(19) United States
(12) Patent Application Publication
(10) Pub. No.: US 2024/0267209 A1
(43) Pub. Date: Aug. 8, 2024

(54) Preventing Password Cracking and Acceptance of Cracked Passwords

(71) Applicant: International Business Machines Corporation, Armonk, NY (US)

(72) Inventors: Chunlong Liang, Austin, TX (US); James T. Mulvey, Red Hook, NY (US); Jose Angel Rodriguez, Austin, TX (US); Jose I. Ortiz, Raleigh, NC (US); Xiaoyan Yanni Zhang, Austin, TX (US)

(21) Appl. No.: 18/107,086

(22) Filed: Feb. 8, 2023

(51) Int. Cl. H04L 9/08; H04L 9/32

(52) U.S. Cl. CPC H04L 9/0863; H04L 9/3242

(57) ABSTRACT

Mechanisms are provided for salted password protection of computing resources. An entity identifier and password for authenticating an entity to access a protected computing resource are received. A salt value is generated as a random value that is combined with the password to generate a salted password. A hash value is generated based on a hash function and the salted password as an input to the hash function. Based on the password, an encryption key is generated for encrypting the salt value. The salt value is encrypted based on the encryption key and an encryption algorithm to generate an encrypted salt value. The entity identifier, hash value, and encrypted salt value are stored in a secured database for later retrieval to validate subsequent access requests specifying the entity identifier.

### BACKGROUND

The present application relates generally to an improved data processing apparatus and method and more specifically to an improved computing tool and improved computing tool operations/functionality for password security in computing systems by preventing password cracking and acceptance of cracked passwords.

Computer security is a significant problem in the present information technology based society. Many security mechanisms are based on password protections, requiring authorized users to have passwords that prove the identity of a user to the computing system and thereby indicate that user's permission to access the computing system resources. Thus, password security is a primary concern in such password-based computer security systems. Many mechanisms are used to try to ensure the security of such passwords so that unauthorized or nefarious parties, i.e., attackers, are not able to gain access to such passwords and obtain unauthorized access to the password-protected computer systems.

However, these mechanisms have been shown to not be sufficient as significant security breaches of computer systems where attackers are able to access security information and passwords for users occur on a regular basis. For example, in the calendar year 2021, significant security breaches exposing user passwords occurred with major companies such as Ticketmaster (January 2021), Microsoft (March 2021), GoDaddy (November 2021), and even government organizations, such as New York City Law Department (June 2021).

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for salted password protection of computing resources. The method comprises receiving an entity identifier and password for authenticating an entity to access a protected computing resource. The method further comprises generating a salt value as a random value that is combined with the password to generate a salted password. In addition, the method comprises generating a hash value based on a hash function and the salted password as an input to the hash function. Moreover, the method comprises generating, based on the password, an encryption key for encrypting the salt value, and encrypting the salt value based on the encryption key and an encryption algorithm to generate an encrypted salt value. The method also comprises storing the entity identifier, hash value, and encrypted salt value in a secured database for later retrieval to validate subsequent access requests specifying the entity identifier.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example block diagram of the primary operational components of an encrypted salt based password security system in accordance with one illustrative embodiment;

FIG. 2 is a flowchart outlining an example operation for generating an encrypted salt based secured database entry in accordance with one illustrative embodiment;

FIG. 3 is a flowchart outlining an example password validation operation of an encrypted salt based password security system in accordance with one illustrative embodiment;

FIG. 4 is an example block diagram of an encrypted salt based password security system that utilizes client side salt and server side salt in accordance with one illustrative embodiment;

FIG. 5 is a flowchart outlining an example operation for generating an encrypted salt based security database entry using combined client and server side salt in accordance with one illustrative embodiment;

FIG. 6 is a flowchart outlining an example password validation operation of an encrypted salt based password security system that uses combined client and server side salt in accordance with one illustrative embodiment; and

FIG. 7 is an example diagram of a distributed data processing system environment in which aspects of one or more of the illustrative embodiments may be implemented, and at least some of the computer code involved in performing the inventive methods may be executed.

### DETAILED DESCRIPTION

With password-based security in computing systems, it is essential to store passwords in a way that prevents them from being obtained by an attacker even if the computer system, application, database, or the like, is compromised. Moreover, it is important for such computer systems, applications, database, or the like, to automatically detect and reject compromised (or “cracked”) passwords, so that the computer system, applications, database, or the like is not further compromised.

One way in which passwords may be stored in a more secure manner is to use “salted password hashing.” With salted password hashing, some random bits are added to each password, where these random bits are the “salt”, before the password is hashed and the hash value is stored along with the username. That is, after the salted password hashing is applied, the password storage system stores the username, password hash, and plain text salt together in a secured database. Thus, for example, if a user, e.g., John Smith, has a username of John.Smith123, and a password of “password”, then salt may be added to the password to generate a salted password of “password$G1%3”, where the salt is the random value “$G1%3” in this example. This salted password would then be hashed using a hashing function to generate a hash value that is stored along with the username John.Smith123 and the salt “$G1%3” in plain text.

When a requestor (e.g., user input request to a computing device, application, or the like) wishes to request access to a computing system, application, database, data structure, or any other secured computing resource (collectively referred to herein as computing resources), the user submits the username, e.g., “John.Smith123”, and an input password, e.g., “password”. The username is used to look-up the password hash value and the plain text salt in the secured database. The plain text salt is used along with the input password and a hashing algorithm to generate a hash value of the input password, e.g., hash value=hash(password+plain text salt), and that hash value for the input password is compared to the stored password hash for the given username to determine if there is a match, i.e., if the user has submitted the correct password. If there is a match, then the access to computing resources is authorized. If there is not a match, e.g., because the wrong password is used as a basis for the generation of the password hash, then access to the computing resources is not authorized. A benefit is that the secured database does not store the user's password itself, but rather the hash of the password, such that the attacker would need to not only know the salt, but also what hashing function is used to generate the hashed value, in order to access or crack the password.

Although plain text salt makes password cracking more difficult, the storage of the salt as plain text in the secured database makes it possible for an attacker to use brute force cracking of passwords to discover the password if they are able to compromise the secured database and access the plain text salt. That is, if the attacker has access to the salt and hash function, the attacker need only use brute force to again guess the password by trying every password possibility until a matching hash value is found. The brute force attack is one in which the attacker systematically goes through every possibility for the clear text password, combining it with the plain text salt obtained by compromising the secured database, and generating a hash value that is compared to the stored hash value. This is done repeatedly until the attacker comes upon the particular password that, when salted with the known plain text salt, results in a correct hash, and thereby providing access to the actual password. In the event that an attacker is able to successfully perform such a brute force attack and obtain the password, the attacker may then utilize the cracked password to access the secured computing system, application, database, data structure, or the like (computing resources), if such secured computing resources do not have a native mechanism to detect and prevent such cracked passwords from being used to access the computing resources.

The illustrative embodiments provide mechanisms for improved salted password hash-based password security computing systems in which improvements are provided in both the salted password hash generation, and in the way that salted password hashes are stored in computing systems to protect their computing resources from attackers. With regard to salted password hash generation, with the mechanisms of the illustrative embodiments, the password salt is stored as an encrypted value in the secured database rather than as plain text salt. Moreover, the encrypted salt value is encrypted with a key value derived from the user's password itself. In some cases, the key value may be the user's password itself, and in other cases the key value may be some other value derived from the user's password using a key value generation algorithm. Thus, the password is a basis for encrypting the salt value that in turn is a basis for encrypting the password via the hashing function, in a circular fashion.

It should be appreciated that the key value generation algorithm may take many different forms depending on the desired implementation. For example, in some illustrative embodiments, the key value algorithm may derive a key value from the password, from the combination of the password and the user name, e.g., the entire combination or a portion of the combination of the password and user name, from a predetermined portion of the password (e.g., first X characters, last Y characters, etc.), from the password and a password creation time, from the password, and a last access time (in this case the encryption key would need to be updated after each access), and from the password and access statistics (e.g., login count, etc., which again would require encryption key updates after each access).

In some illustrative embodiments, the key value may be derived by regenerate password salt, and encrypting the salt value with the password after each login operation. That is, in some illustrative embodiments, the password salt is regenerated after each login, e.g., a random character string is generated to be the salt after each login, and used to recalculate the password hash dynamically with each successful login. In such cases, the salt is re-encrypted with one of the encryption key mechanisms discussed above.

When password validation is being performed, the password validation algorithms need to first decrypt the salt by using the appropriate key (based on the user's password or a key value derived from the user's password), before using it in the hash calculation. Thus, if an attacker is able to access or compromise the secured database, the attacker would only be able to access the encrypted salt value rather than a plain text salt. The attacker would then need to decrypt the encrypted salt successfully in order to then perform a brute force attack on the password, as discussed above. However, the attacker will not know whether the encrypted salt is plain text salt or encrypted salt.

Thus, the attacker may first assume that the accessed value is a plain text salt and attempt brute force determination of the password using the encrypted salt value as a plain text salt, which would result in none of the attempted passwords resulting in a correct hash value, i.e., a hash value matching the stored hash value. Thereafter, the attacker might assume that the encrypted salt value is an encrypted salt value, but then would have to successfully crack the encryption of the salt value before then again attempting a brute force attack on the password having decrypted the encrypted salt value. However, as the salt value is a random value, the attacker cannot be sure that any decrypted salt value is in fact the correctly decrypted salt value. This makes decrypting the salt value difficult to accomplish without knowing specifically the encryption key. Moreover, as the encryption key in the illustrative embodiments is based on the password being encrypted, and this is the value that the attacker is assumed to not know and thus, is the focus of the attack, this makes obtaining the encryption key difficult if one does not know the password and the algorithm for generating the encryption key.

Hence, in order to brute force determine the password, the attacker will have to brute force attack both the password and the password salt, which requires an effort and expenditure of resources similar to a brute force attack on a very long and security generated random password. Thus, if one considers that cracking a password with plain text salt requires n computations, cracking a password with encrypted salt requires at least n*n computations assuming that the password and salt have the same size. Thus, if cracking a password with plain text salt needs 10 days of computations using brute force, cracking a password with encrypted salt would require at least 100 days of computation, and most likely would not be able to be performed successfully.

With the improved salted password hash based security computing system operations of the illustrative embodiments, when generating a salted password, the operation first generates the password salt in a randomized manner and combines it with the password to generate a salted password. The salted password is input to a hashing function that calculates a hash value on the salted password. A key is derived from the password and used to encrypt the plain text salt value to generate an encrypted salt value. Again, this key may be the password itself, or it may be some other value generated from the password, e.g., an algorithm that calculates some other value based on the contents of the password may be utilized. In some cases, the password may be padded with additional characters or values to generate longer encryption keys, and these padding values may be fixed values or randomly generated values.

It should be appreciated that while the illustrative embodiments are described with the key value being derived from the password itself, in other illustrative embodiments, the key value may not be the password or derived from the password. That is, in some illustrative embodiments, the key value may be provided by a local password server, or by a remote security vault or secret key service. However, preferred embodiments make use of key values derived from the password itself as it does not require a separate maintenance of key values, since the key value can be generated at any time if the correct password is provided by the requestor.

The key value is used to encrypt the salt value. The encrypted salt value is then stored with the password hash value and username in the secured database. Thus, the key value is not stored, and the plain text salt value is not stored in the secured database. Hence, if the secured database is compromised, the attacker would still need to know the key value to decrypt the encrypted salt value to gain access to the plain text salt in order to perform a brute force attack on the password. As the attacker will not know when the encrypted salt value is successfully decrypted, attempts to brute force attack passwords protected by the mechanisms of the illustrative embodiments become unfeasible and potentially impossible.

In order to verify a password entered by a user, the security system of the illustrative embodiments uses the username to retrieve the corresponding entry in the secured database and retrieve the hash value and encrypted salt value. The user provided password is used to generate a key value in accordance with the key value algorithm, or using the password itself as the key value. The key value is used to decrypt the encrypted salt value, which if the password is correct, will successfully decrypt the encrypted salt value to generate the correct plain text salt value, but if the password is incorrect, will result in an incorrect plain text salt value. As the plain text salt value is a random value, it will be impossible to distinguish correct plain text salt values from incorrect plain text salt values at this time.

The decrypted plain text salt value is then used with the provided input password to generate a hash value using the hashing algorithm. The generated hash value is then compared to the stored hash value to determine if there is a match and access to computing resources is to be permitted or not.

Thus, in these illustrative embodiments, brute force attempts to determine user passwords is made practically impossible even if an attacker is able to breach the security of the secured database storing user account information that includes the username, salted password hash, and encrypted salt value. That is, the attacker cannot discern the salt value as being a plain text salt value or encrypted salt value, and even if assuming the salt value to be an encrypted salt value, will not be able to successfully decrypt the encrypted salt value, especially when the security key for decrypting the salt value is based on the password, which the attacker is attempting to discern. As the salt value is a randomized value, the attacker will not know if the decrypted value generated is an actual plain text salt value or an incorrectly decrypted plain text salt value. Furthermore, as the secured database does not store the user's password or the key value used to encrypt the salt value and generate the stored encrypted salt value, the attacker, even if able to compromise the secured database, will not be able to gain access to this information. Moreover, it is not practical for an attacker to make the necessary brute force attempts to discern the security key, and then also brute force attempts to determine the password from the plain text salt.

In further improved computing tools and improved computing tool operations of one or more illustrative embodiments, rather than operating based on a single salt value generated by the security system, the salt value may in fact be a combination of a security system generated salt value (referred to as a server side salt value, as it is assumed that server computing systems are used to implement the security system) and a client side salt value. With these illustrative embodiments, the server side salt is generated in a similar manner as discussed above with regard to generating randomized bits to be added to the user password. However, the server side salt is not stored in the secured database. To the contrary, during password creation, the user's password manager application sends random bits, referred to herein as the client side salt or simply client salt, to the security system, which may be implemented on one or more computing systems, e.g., servers, for protecting computing resources using password validation. The client salt may be supplied in an encrypted form so as to further secure the client salt from unwanted identification.

At the security system, a hash value is still computed based on a combination of the user's password and a salt value, however in these illustrative embodiments, the salt value is a combination of the client side salt and a salt value generated at the security system, referred to as the server side salt or server salt. That is, similar to the client salt, the security system generates its own random bits that are the server salt and combines that server salt with the client salt supplied by the client during password creation. The combining of the server salt with the client salt may be an appending of the server salt to the client salt, or any other suitable mechanism or integrating the server salt with the client salt to generate a combined salt value. The combined salt value is then combined with the password to generate a combined salted password that is submitted to the hashing function to generate a hash value. The client salt value may also be used as an encryption key to encrypt the server salt. Alternatively, as discussed above with regard to the other illustrative embodiments, an encryption key may be generated based on the password or a value derived from the password, which may then be used to encrypt the server salt.

The secure database of user account information stores the username, the combined salted password hash value, and the encrypted server salt. The secure database does not store the client salt value. Thus, even if an attacker were to compromise the secure database, the attacker would again only gain access to the user name, combined salted password hash value, and the encrypted server salt, but would not have access to the client salt value which is used as the key to encrypt the server salt, and is further required to generate the combined salt value used to generate the combined salted password hash value. Hence, even if the attacker attempted to decrypt the server side salt, and even if somehow successful, which is unlikely, the attacker still would not know the client side salt (as the attacker may not know that client side salt is being used as the encryption key), and would not be able to generate the combined salt value to gain access to the password through a brute force attack on the combined salted password hash value.

During password validation, a user may submit their username and password for validation, and the password manager of the client will send the client side salt (potentially encrypted, such as using private-public key encryption) along with the username and password submitted by the user. The security system, receiving the username, password, and client side salt may then use the client side salt (potentially after decryption) to decrypt the stored encrypted server side salt in the entry of the secured database retrieved based on the supplied username. The decrypted server side salt is then combined with the supplied client side salt to generate a combined salt value which is combined with the supplied password. A hash function is then executed on the combination of the combined salt value and the supplied password to generate a hash value for the user input. This hash value is compared to the stored hash value to determine if there is a match. If there is a match, then access to computing resources may be authorized. If there is not a match, then access will be denied by the security system.

Thus, in some illustrative embodiments, password creation involves computer options where a user uses their client side password manager application to request or set a password for use with the server side security system. The password manager generates high entropy random bits (client salt) to be associated with this password request, and stores it locally for future use. The password manager sends the client salt (potentially encrypted) along with the new password request, which may include the user specified password, or may be a request for the server side security system to generate a password. Upon receiving the password request and potentially the password, the security system generate server side salt for the new password. The security system combines the client salt with the server salt to generate a combined salt value which is then added to the password. The combined salted password is then submitted to a hashing function which generates a hash value based on the combined salted password. The security system encrypts the server salt with the client salt as an encryption key, or may utilize the password based encryption key mechanism previously described above in some illustrative embodiments. The encrypted server salt is stored along with the combined salted password hash value and the username in a secured database, such as part of a user account information data structure.

During password validation, a user may submit their username and password, and their client side password manager application may provide the previously stored client side salt (potentially encrypted). The username is used to retrieve the entry in the secured database for this username and the supplied client side salt is used to decrypt the server side salt, where the client salt is used as the decryption key. The server side salt is combined with the client salt to generate a combined salt value which is combined with the supplied password and a hash value is generated based on the combination of the combined salt value and the supplied password. The hash value is compared to the stored hash value and if there is a match, access to computing resources is authorized; otherwise, it is denied.

It can be seen from the above, that this strategy provides at least two layers of protection for passwords. In the password storage, the password hash itself is protected by an encrypted salt instead of plain text salt and this encrypted salt is encrypted in a specific manner using client side salt and server side salt that makes it practically impossible for an attacker to identify the combined salt value and thus, generate a correct hash value. As the attacker can never access the client side salt, as the secured database does not store the client side salt, the attacker cannot gain access to the computing resources, even if the attacker is able to crack the password itself.

Thus, it should be appreciated that this password validation strategy completely defeats password cracking using brute force attacks, as the attacker cannot access the client side salt. In the event the attacker can crack the password, the attacker does not have the client side salt to generate the combined salt value to generate the correct hash value. Thus, these illustrative embodiments employing the combined salt values provide two significant dimensions of protection, i.e., the mechanisms prevent password cracking, and also prevent the use of cracked passwords.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

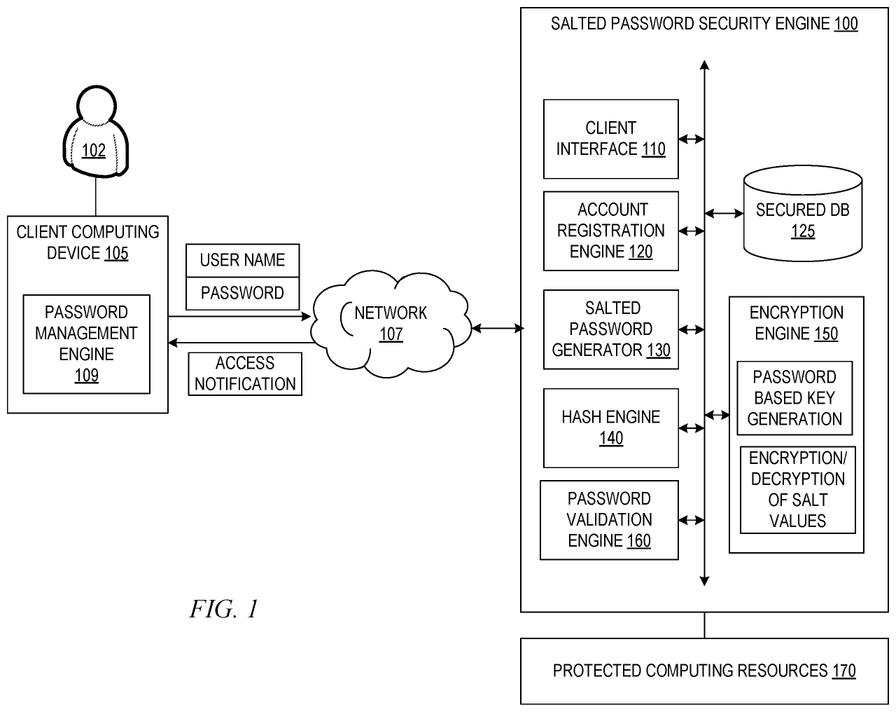

FIG. 1 is an example block diagram of the primary operational components of an encrypted salt based password security system in accordance with one illustrative embodiment. The operational components shown in FIG. 1 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., access requests with usernames and passwords, and the resulting output may aid human beings, e.g., by providing or denying access to protected computing resources. The invention is specifically directed to the automatically operating computer components directed to improving the way salted password protection of computing resources is implemented, and providing a specific solution that implements specific computer security operations to protect and control access to computing resources based on salted password protections, where these operations cannot be practically performed by human beings as a mental process and are not directed to organizing any human activity.

The illustrative embodiments provide mechanisms for improved salted password hash-based password security computing systems in which improvements are provided in both the salted password hash generation, and in the way that salted password hashes are stored in computing systems to protect their computing resources from attackers. As shown in FIG. 1, the salted password based security engine 100 includes a client interface 110 which provides the logic for interfacing with entities associated with client computing devices, e.g., client computing device 105 via wired/wireless data network(s) 107, where these entities may be users of the client computing devices, applications executing on the client computing devices, or the like. The client interface 110 may be used to obtain identifier information and password information for the entity associated with the client computing device 105, e.g., a username and password for a user of the client computing device 105. The account registration engine 120 provides logic for accessing and managing account entries in the secured database 125. The account entries store the account data for identifying authorized entities for accessing the backend protected computing resources 170, e.g., the username, a hash value of a salted password, and the encrypted salt, as discussed in greater detail hereafter. The account registration engine 120 may provide logic for generating such account entries in the secured database 125 as well as performing lookup operations and retrieving of account entries from the secured database 125.

The salted password based security engine 100 further includes a salted password generator 130 that comprises logic for randomizing a salt value and adding it to a password provided by the client computing device 105, such as a user 102 specified password obtained via the client interface 110. A hash engine 140 of the salted password based security engine 100 operates on the salted password generated by the salted password generator 130 to generate a hash value. The salted password based security engine 100 further includes an encryption engine 150 that operates on the generated salt value, generated by the salted password generator 130, to encrypt the salt value for storage in the account entry in the secured database 125 in association with the identifier, e.g., username, and generated hash value which is generated based on the salted password.

The encryption engine 150 comprises logic, or a key value algorithm, for generating an encryption key based on the password provided by the entity, which will be assumed to be a user 102 for this discussion, but may be an application or other automated mechanism. The encryption key may be the password itself, or some other value derived from the password. As noted above, in some cases this derived value may be derived from the combination of the password and the user name, from a predetermined portion of the password and/or the user name (e.g., first X characters, last Y characters, etc.), from the password and a password creation time, e.g., appending the creation time to the password and using the combination as an encryption key, from the password and a last access time (in this case the encryption key would need to be updated after each access), such as through again appending the last access time to the password to generate the key value, and from the password and access statistics (e.g., login count, etc., which again would require encryption key updates after each access), such as through appending the statistical value to the password to generate the key value. In some illustrative embodiments, the key value may be derived by regenerate password salt, and encrypting the salt value with the password after each login operation. In the case of encryption keys that are generated based on the password and temporal values, e.g., last access time, time of password creation, or access statistics, the client computing device 105 may have a password management engine 109 that maintains such temporal values and/or statistical values, which may be submitted with the password as part of an access request, such that these values are not stored in the salted password security engine 100 or secured database 125, but are provided to the salted password security engine 100 for use in generating the key value for decrypting the encrypted salt value. It should be appreciated that these are only examples and many other algorithms for key value generation based on the password may be used without departing from the spirit and scope of the present invention.

Thus, when the account entry is created, such as when a user 102 registers to access protected computing resources 170, the user 102 may register a username and provide a corresponding password via their client computing device 105, which is entered via one or more user interfaces provided via the client interface 110. The salted password generator 130 generates the salt value and salts the password. The salt value is a random set of bits that are added to the password, such as appended to the password provided by the user or otherwise integrated into the password, e.g., interleaving the salt value characters into the characters of the password in accordance with a salting algorithm. The salt value is encrypted using the encryption key generated by the encryption engine 150, where the encryption key is based on the password such that a circular protection is achieved in that the encryption key is based on the value it encrypts. The salted password is input to the hash engine 140 which generates a hash value by applying a hashing function to the input salted password.

The resulting account entry stores, in the secured database 125, the username, the hash value, and the encrypted salt value, but does not store the password, the plain text salt, or the encryption key used to encrypt the salt value. Moreover, in cases where the encryption key is based on a combination of the password and other temporal values or statistical values, the secured database 125 also does not store these temporal values or statistical values. Thus, an attacker, even if able to access the secured database 125 and gain access to the information in the account entry, will still not be able to discern the user's password or gain access to the backend protected computing resources 170. This is because the attacker does not have access to the encryption key, and cannot recreate the encryption key, such that the attacker will not be able to decrypt the encrypted salt value. Moreover, the attacker may not be able to determine whether the encrypted salt value is in fact an encrypted salt value or a plain text salt value, as the salt value itself is a randomized set of bits. Hence, the attacker would need to expend an impractical amount of time and resources attempting to crack the password with a low likelihood of success. However, the salted password security engine 100 is still able to decrypt the encrypted salt value to perform password validation if a requestor submits the correct password, as the salted password security engine 100 is able to regenerate the encryption key from the correct password, and potentially the username, temporal values, or statistical values, depending upon the implementation.

At a later point after registration and creation of the account entry in the secured database 125, when a requestor, such as user 102 for example, an application executing on the client computing device 105, or the like, wishes to gain access to the backend protected computing resources 170, the requestor submits a request to access the backend protected computing resources 170, e.g., a backend database, data structures, applications, or any other computing resource that may be utilized by users 102 or applications via client computing devices 105. For example, the user 102 attempts to login to the service or system providing the protected computing resources 170 and the salted password based security engine 100 intercepts the login request. The login request may specify the identity of the entity requesting access, e.g., the username of the user, and a password for verifying the identity of the entity, and potentially other stored temporal or statistical values that may be used to generate a decryption key.

The password validation engine 160 provides logic for performing password validation based on the supplied identifier, e.g., username, password, and potentially other temporal/statistical values, as well as the stored account information in the secured database 125. When password validation is being performed, the password validation algorithms of the password validation engine 160 need to first retrieve the account entry from the secured database 125 based on the identifier, e.g., username, and then decrypt the salt value by using the appropriate decryption key (based on the user's password or a key value derived from the user's password), before using it in the hash calculation. In order to decrypt the salt value, the password validation engine 160 may call the encryption engine 150 to generate a key value based on the password supplied in the access request. The encryption engine 150 uses a same methodology as previously used to generate the key value when encrypting the salt value, but this time based on the supplied password. Thus, if the supplied password is incorrect, then the key value will be incorrect and result in an incorrect decryption of the salt value. If the supplied password is correct, then the key value will be the same key value used to encrypt the salt value, and thus, a correct decryption of the encrypted salt value is achieved to thereby gain access to the plain text salt value.

The user provided password is used to generate a key value in accordance with the key value algorithm of the encryption engine 150, or using the password itself as the key value. The key value is used to decrypt the encrypted salt value and the decrypted plain text salt value is then used with the provided input password to generate a hash value using the hashing algorithm of the hash engine 140. The password validation engine 160 compares the generated hash value to the stored hash value retrieved with the account information from the secured database 125 to determine if there is a match and access to the backend protected computing resources 170 is to be permitted or not. If there is a match, an access notification response is sent to the requestor at client computing device 105 authorizing access to the backend protected computing resources 170. If there is not a match, an access notification response is sent to the requestor at the client computing device 105 denying access to the backend protected computing resources 170.

Thus, in these illustrative embodiments, brute force attempts to determine user passwords is made practically impossible even if an attacker is able to breach the security of the secured database storing user account information that includes the username, salted password hash, and encrypted salt value. That is, the attacker cannot discern the salt value as being a plain text salt value or encrypted salt value, and even if assuming the salt value to be an encrypted salt value, will not be able to successfully decrypt the encrypted salt value, especially when the security key for decrypting the salt value is based on the password, which the attacker is attempting to discern. As the salt value is a randomized value, the attacker will not know if the decrypted value generated is an actual plain text salt value or an incorrectly decrypted plain text salt value. Furthermore, as the secured database 125 does not store the user's password or the key value used to encrypt the salt value and generate the stored encrypted salt value, the attacker, even if able to compromise the secured database 125, will not be able to gain access to this information. Moreover, it is not practical for an attacker to make the necessary brute force attempts to discern the security key, and then also brute force attempts to determine the password from the plain text salt.

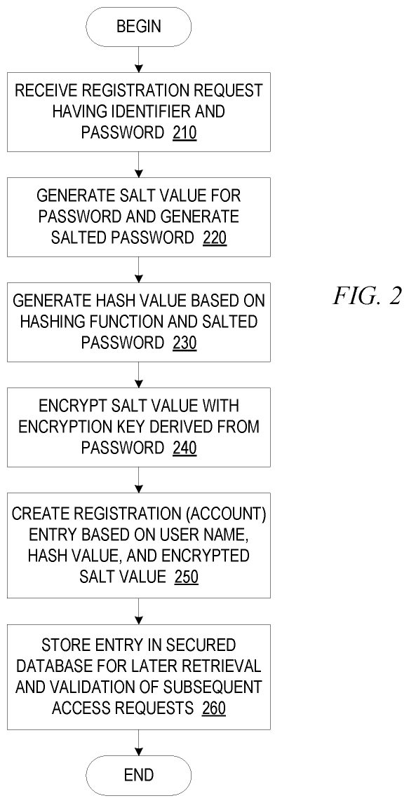

FIGS. 2-3 and 5-6 present flowcharts outlining example operations of elements of the present invention with regard to one or more illustrative embodiments. It should be appreciated that the operations outlined in FIGS. 2-3 and 5-6 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 2-3 and 5-6, and may, in some cases, make use of the results generated as a consequence of the operations set forth in FIGS. 2-3 and 5-6, the operations in FIGS. 2-3 and 5-6 themselves are specifically performed by the improved computing tool in an automated manner.

FIG. 2 is a flowchart outlining an example operation for generating an encrypted salt based secured database entry in accordance with one illustrative embodiment. The operation outlined in FIG. 2 may be implemented, for example, by a salted password based security system, such as 100 in FIG. 1. It should be appreciated that the operations set forth in FIG. 2, as well as the other flowcharts in the present application, are intended to be performed automatically by specifically configured computing devices implementing the particular ordered combination of computer operations of an improved computing tool and improved computing tool functionality of one or more of the illustrative embodiments.

As shown in FIG. 2, the operation starts by receiving a request to register an account to access protected computing resources, where the request specifies an identifier of the requestor, e.g., username, and a password for verifying the identity of the requestor (step 210). A salt value is generated for the password and used to generate a salted password (step 220). The salted password is processed by a hashing function to generate a hash value (step 230). The salt value is encrypted with an encryption key derived from the password (step 240). The account entry is created based on the username, the hash value, and the encrypted salt value (step 250) and stored in the secured database for later retrieval and use in validating subsequent access requests (step 260). The operation then terminates.

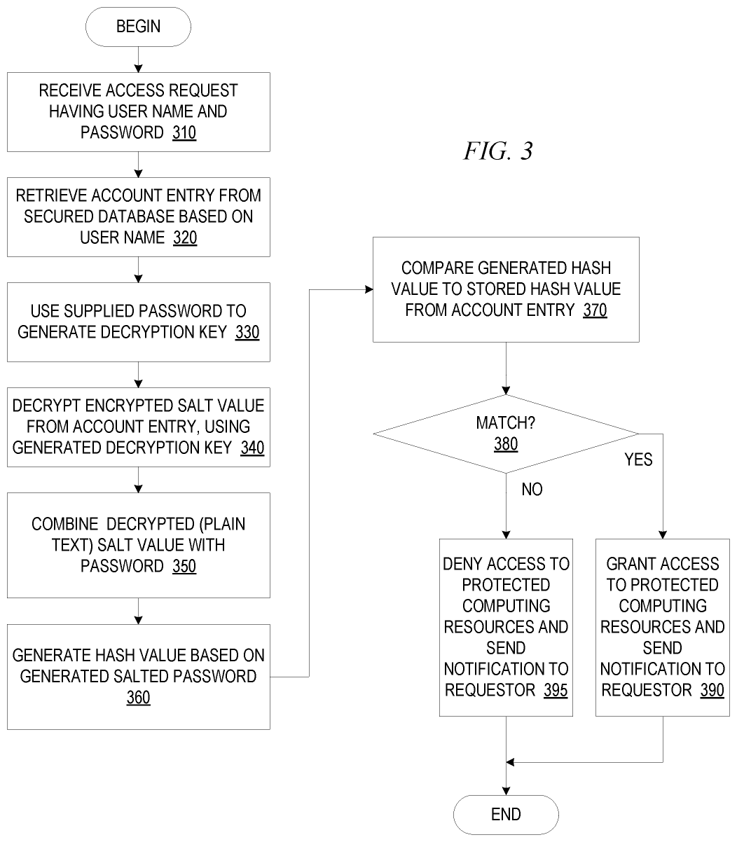

FIG. 3 is a flowchart outlining an example password validation operation of an encrypted salt based password security system in accordance with one illustrative embodiment. Again, the operation outlined in FIG. 3 may be implemented, for example, by the salted password based security system, such as 100 in FIG. 1.

As shown in FIG. 3, the operation starts by receiving a request to access protected computing resources, e.g., a user login attempt or the like, where the request specifies an identifier of the requestor, e.g., a username, and a password for identifying the requestor (step 310). The account entry corresponding to the username is retrieved from the secured database to thereby access the associated hash value and encrypted salt value (step 320). The supplied password is used to derive a decryption key (step 330). The derived decryption key is then used to decrypt the encrypted salt value to generate a plain text salt value (step 340). The plain text salt value is combined with the supplied password (step 350) and input to the hashing function to generate a hash value (step 360). The generated hash value is compared to the stored hash value in the retrieved account entry to determine if there is a match (step 370). If there is a match (step 380), access is granted to the protected computing resources and an appropriate response is returned to the requestor (step 390). If there is not a match, then access is denied, and an appropriate response is returned to the requestor (step 395). The operation then terminates.

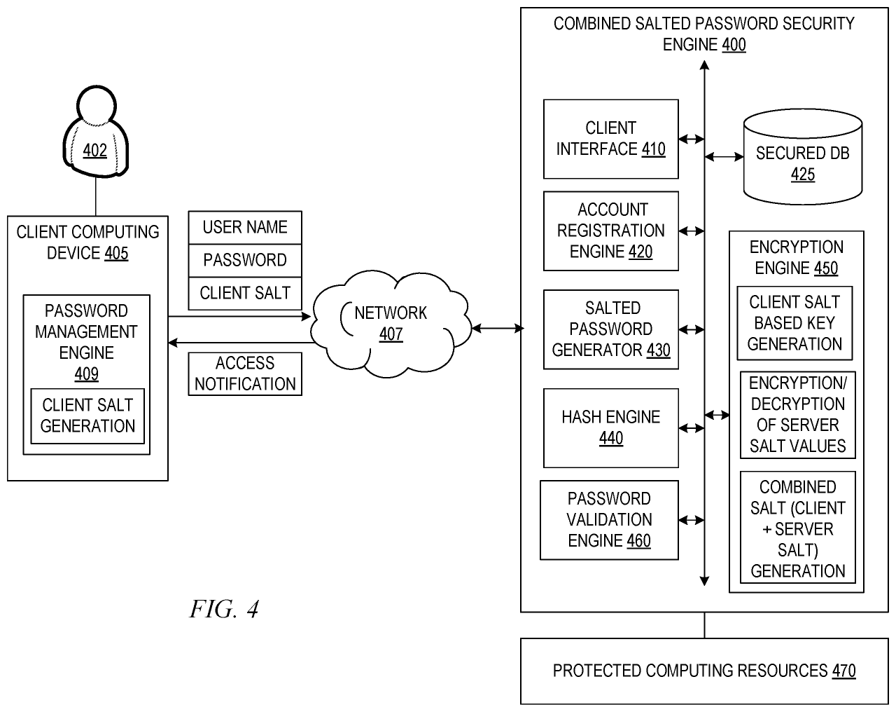

FIG. 4 is an example block diagram of an encrypted salt based password security system that utilizes client side salt and server side salt in accordance with one illustrative embodiment. FIG. 4 is an example of a further improved computing tools and improved computing tool operations of one or more illustrative embodiments that, rather than operating based on a single salt value generated by the security system, the salt value may in fact be a combination of a security system generated salt value (referred to as a server side salt value, as it is assumed that server computing systems are used to implement the security system) and a client side salt value. In doing so, even greater protections are made possible by providing another value that is required to access protected computing resources, which is difficult or impossible for an attacker to discern or gain access to.

With these illustrative embodiments, the combined salted password security engine 400 in FIG. 4 is similar to the salted password security engine 100 in FIG. 1, but with different computer functionality in some of the engines, e.g., to facilitate the use of combined client/server salt and encryption based on client salt, and with differences in the interaction between the combined salted password security engine 400 and the client computing device 405 which executes a password management engine 409 that generates client side salt, as discussed hereafter. In this improved computing tool and improved computing tool functionality, the server side salt is generated in a similar manner as discussed above with regard to generating randomized bits to be added to the user password, and may be generated by the salted password generator 430 similar to 130 in FIG. 1. However, the server side salt is not stored in the secured database 125. To the contrary, during password creation, the user's password management engine 409 sends random bits, referred to herein as the client side salt or simply client salt, generated by the password management engine 409, to the combined salted password security engine 400, which may be implemented on one or more computing systems, e.g., servers, for protecting computing resources 470 using password validation. The client salt may be supplied in an encrypted form so as to further secure the client salt from unwanted identification.

The account registration process is similar to that described previously with regard to FIG. 1, but with the addition of the generation of the client salt and providing the client salt to the security engine 400 for use in generating combined salt which is used to salt the password provided by the entity (user, application, or the like) as part of the registration process. Thus, again, when the entity registers as an authorized accessor of the backend protected computing resources 470, the entity provides their identifier (e.g., username) and password that they wish to use to authenticate themselves. The password management engine 409 automatically generates a client salt value, e.g., a randomized set of bits, which are sent (potentially encrypted) along with the identifier and password for use in registering the entity as an authorized accessor of the backend protected computing resources 470. However, it should be appreciated that while the client salt is used to register the entity, the client salt is not maintained or stored in the secured database 425 or otherwise stored by the security engine 400. The registration process and other interactions between the security engine 400 and the client computing devices 405 may be performed via the client interface 410, and account registration may be performed by the account registration engine 420.

At the security engine 400, a hash value is still computed based on a combination of the user's password (as provided by user 402 via the client computing device 405 and network 407) and a salt value, however in these illustrative embodiments, the salt value is a combination of the client side salt and a salt value generated at the security engine 400, referred to as the server side salt or server salt. That is, similar to the client salt generated by the password management engine 409 at the client computing device 405, the salted password generator 430 of the security engine 400 generates its own random bits that are the server salt and combines that server salt with the client salt. The combining of the server salt with the client salt may be an appending of the server salt to the client salt, or any other suitable mechanism or integrating the server salt with the client salt to generate a combined salt value. The combined salt value is then combined with the password to generate a combined salted password that is submitted to the hashing function of the hash engine 440 to generate a hash value. The client salt value may also be used as an encryption key by the encryption engine 450 to encrypt the server salt. Alternatively, as discussed above, with regard to the other illustrative embodiments, the encryption engine 450 may generate an encryption key based on the password or a value derived from the password, which may then be used to encrypt the server salt.

The secure database 425 of user account information stores the username, the combined salted password hash value, and the encrypted server salt, which again is only a part of the combined salt needed to generate a correct hash value. The secure database 425 does not store the client salt value. Thus, even if an attacker were to compromise the secure database 425, the attacker would again only gain access to the user name, combined salted password hash value, and the encrypted server salt, but would not have access to the client salt value which is used as the key to encrypt the server salt, and is further required to generate the combined salt value used to generate the combined salted password hash value. Moreover, the attacker may not be able to discern that the encrypted server salt value is in fact encrypted or plain text salt. Even if the attacker assumed that the stored value is an encrypted server salt, and attempted to decrypt the server salt, and even if somehow successful, which is unlikely, the attacker still would not know the client side salt, as the attacker may not know that client side salt is being used as the encryption key and also would not know that the system is even using combined salt as a salt value for generating the hash value, and would not be able to generate the combined salt value to gain access to the password through a brute force attack on the combined salted password hash value.

During password validation, a user may submit their username and password for validation, and the password manager engine 409 of the client computing device 405 will send the client side salt (potentially encrypted, such as using private-public key encryption) along with the username and password submitted by the user. That is, the password manager engine 409, when registering the entity as an authorized accessor of the backend protected computing resources 470, generates the client salt value and stores it in association with the identity of the entity in a local store of the password management engine 409 for later use. Thus, during a subsequent access request, and need for password validation, the password management engine 409 adds to the access request this stored client salt value, such that the access request includes the entity identifier (e.g., username), password, and client salt value, potentially encrypted for greater security.

The security engine 400, receiving the entity identifier (e.g., user name), password, and client salt, may retrieve, by the account registration engine 420, the corresponding entry for the identifier (user name) from the secured database 125 and the encryption engine 450 may operate to use the client salt (potentially after decryption, e.g., using private/public key decryption) to decrypt the stored encrypted server side salt in the retrieved entry. The decrypted server salt is then combined by the salted password generator 430 with the supplied client salt to generate a combined salt value which is combined with the supplied password to generate a combined salted password. The combined salted password is input to the hash engine 440 which applies a hash function on the combination of the combined salt value and the supplied password to generate a hash value for the access request. This hash value is compared by the password validation engine 460 to the stored hash value that is retrieved as part of the entry from the secured database 425, to determine if there is a match. If there is a match, then the password validation engine 460 grants access to the protected computing resources 470, and an appropriate response to the client computing device 405 is returned to grant access to the entity. If there is not a match, the password validation engine 460 may then deny access, and an appropriate response returned to the client computing device 405 indicating denial of access.

Thus, these further illustrative embodiments provide even greater protections of passwords by basing the salt values on a combination of client and server side salt values that are stored in distributed locations such that an attacker will be unlikely to be able to gain access to these salt values. These mechanisms make it unlikely for an attacker to gain access to the password, and furthermore provide mechanisms that, should an attacker somehow gain access to the password, would still not be able to access the backend protected computing resources as the attacker still would not be able to correctly generate the necessary hash values to authenticate themselves.

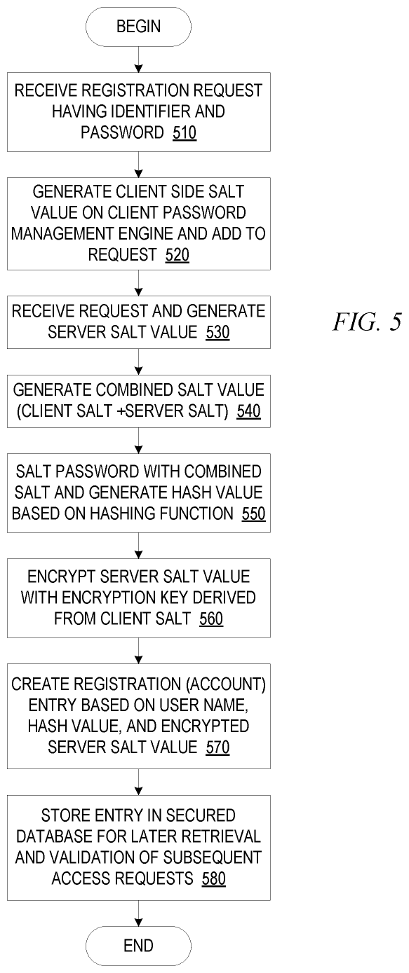

FIG. 5 is a flowchart outlining an example operation for generating an encrypted salt based security database entry using combined client and server side salt in accordance with one illustrative embodiment. The operation outlined in FIG. 5 may be implemented, for example, by the combined salted password security engine 400 in FIG. 4.

As shown in FIG. 5, the operation starts by receiving a request to register an account to access protected computing resources, where the request specifies an identifier of the requestor, e.g., username, and a password for verifying the identity of the requestor (step 510). A client side salt value is generated by a client password management engine and added to the request (step 520). The password management engine 409 generates high entropy random bits (client salt) to be associated with this password request, and stores it locally for future use.

Upon receiving the request with the identifier (username), password, and client salt, the security system generates a server salt value (step 530) and combines the server salt value with the client salt value to generate a combined salt value (step 540). The combined salt value is used to salt the password and generate a hash value based on the combined salted password (step 550). The server salt is encrypted using the client salt as an encryption key for the encryption of the server salt (step 560). The account entry is created based on the identifier (e.g., username), the hash value generated based on the combined salted password, and the encrypted server salt value encrypted using the client salt value as an encryption key (step 570), which is stored in the secured database for later retrieval and use in validating subsequent access requests (step 580). The operation then terminates.

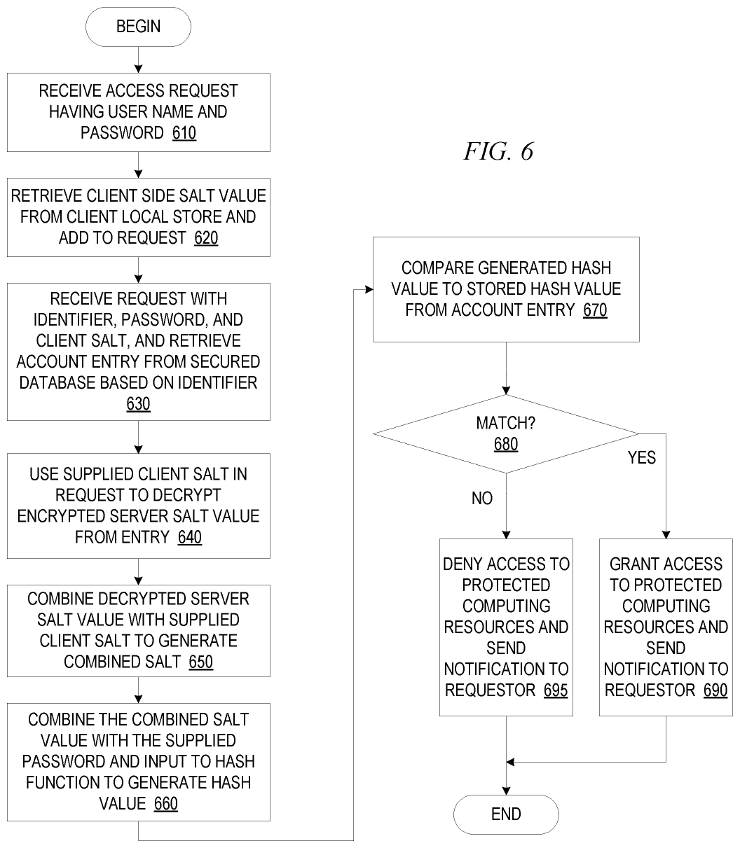

FIG. 6 is a flowchart outlining an example password validation operation of an encrypted salt based password security system that uses combined client and server side salt in accordance with one illustrative embodiment. Again, the operation outlined in FIG. 6 may be implemented, for example, by the combined salted password security engine 400 in FIG. 4.

As shown in FIG. 6, the operation starts by receiving a request to access protected computing resources, e.g., a user login attempt or the like, where the request specifies an identifier of the requestor, e.g., a username, and a password for identifying the requestor (step 610). A client side salt value is retrieved from the local store of the password management engine based on the identity of the requestor, e.g., username, and added to the request (step 620). The access request with the identifier, the password, and the client salt, potentially encrypted, is transmitted to the security system which, upon receive, retrieves the account entry corresponding to the identifier (e.g., username) from the secured database to thereby access the associated hash value and encrypted server salt value (step 630). The supplied client salt is used to decrypt the stored encrypted server salt value (step 640) and the decrypted server salt value is combined with the client salt value to generate a combined salt value (step 650). The combined salt value is combined with the password and input to a hashing function to generate a hash value (step 660). The generated hash value is compared to the stored hash value in the retrieved account entry to determine if there is a match (step 670). If there is a match (step 680), access is granted to the protected computing resources and an appropriate response is returned to the requestor (step 690). If there is not a match, then access is denied, and an appropriate response is returned to the requestor (step 695). The operation then terminates.

It can be seen from the above, that this strategy provides at least two layers of protection for passwords. In the password storage, the password hash itself is protected by an encrypted salt instead of plain text salt and this encrypted salt is encrypted in a specific manner using client side salt and server side salt that makes it practically impossible for an attacker to identify the combined salt value and thus, generate a correct hash value. As the attacker can never access the client side salt, as the secured database does not store the client side salt, the attacker cannot gain access to the computing resources, even if the attacker is able to crack the password itself.

Thus, it should be appreciated that this password validation strategy completely defeats password cracking using brute force attacks, as the attacker cannot access the client side salt. In the event the attacker can crack the password, the attacker does not have the client side salt to generate the combined salt value to generate the correct hash value. Thus, these illustrative embodiments employing the combined salt values provide two significant dimensions of protection, i.e., the mechanisms prevent password cracking, and also prevent the use of cracked passwords.

It is clear from the above description, that the present invention, in accordance with one or more illustrative embodiments, may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides improvements to salted password protection computer mechanisms that are used to protect computing resources and govern access to these protected computing resources. The improved computing tool implements mechanism and functionality, such as the security engines 100 and/or 400, which cannot be practically performed by human beings either outside of, or with the assistance of, a technical environment, such as a mental process or the like. The improved computing tool provides a practical application of the methodology at least in that the improved computing tool is able to generate salted password hash values for protecting computing resources in such a way that attackers are not able to gain access to the passwords and/or salt values used to generate these hash values and thus, will not be able to be authenticated and thereby access protected computing resources.

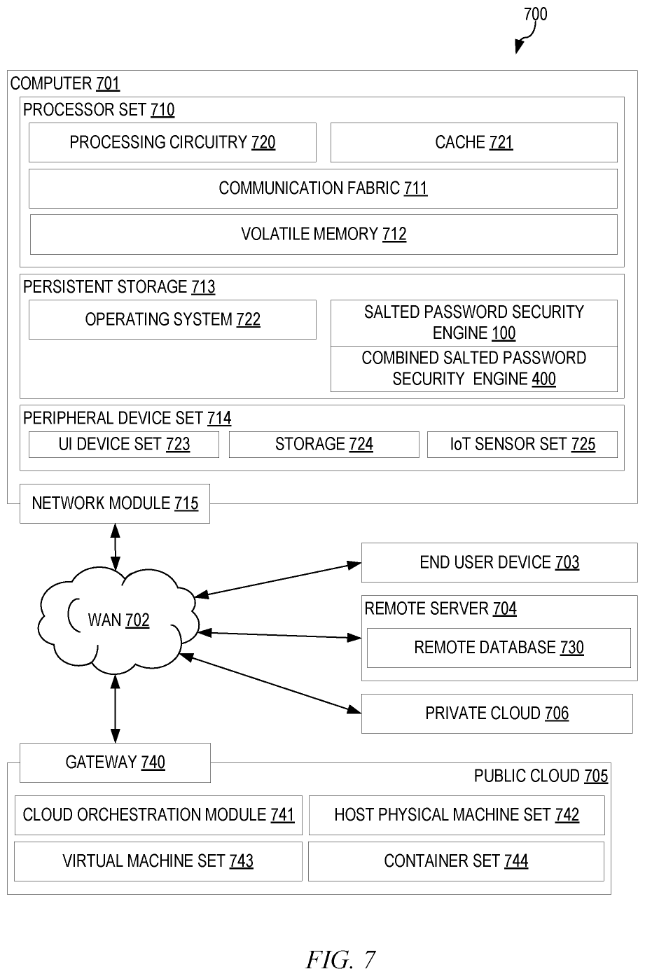

FIG. 7 is an example diagram of a distributed data processing system environment in which aspects of the illustrative embodiments may be implemented and at least some of the computer code involved in performing the inventive methods may be executed. That is, computing environment 700 contains an example of an environment for the execution of at least some of the computer code involved in performing the inventive methods, such as security engine 100 in FIG. 1, or security engine 400 in FIG. 4. In addition to blocks 100 or 400, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722, block 100, and block 400, as identified above), peripheral device set 714 (including user interface (UI), device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

Computer 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

Processor set 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in blocks 100 and 400 in persistent storage 713.

Communication fabric 711 is the signal conduction paths that allow the various components of computer 701 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 712 is any type of volatile memory now known or to be developed in the future. Examples include dynamic type random access memory (RAM) or static type RAM. Typically, the volatile memory is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

Persistent storage 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid state storage devices. Operating system 722 may take several forms, such as various known proprietary operating systems or open source Portable Operating System Interface type operating systems that employ a kernel. The code included in blocks 100 and 400 typically include at least some of the computer code involved in performing the inventive methods.

Peripheral device set 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

Network module 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

Remote server 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

Public cloud 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

As shown in FIG. 7, one or more of the computing devices, e.g., computer 701 or remote server 704, may be specifically configured to implement a security engine 100 or 400, as previously described above. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computing device 701 or remote server 704, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates improved salted password based protection of computing resources.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for salted password protection of computing resources, the method comprising:
receiving an entity identifier and password for authenticating an entity to access a protected computing resource;
generating a salt value as a random value that is combined with the password to generate a salted password;
generating a hash value based on a hash function and the salted password as an input to the hash function;
generating, based on the password, an encryption key for encrypting the salt value;
encrypting the salt value based on the encryption key and an encryption algorithm to generate an encrypted salt value; and
storing the entity identifier, hash value, and encrypted salt value in a secured database for later retrieval to validate subsequent access requests specifying the entity identifier.

2. The method of claim 1, wherein the encryption key is the password.

3. The method of claim 1, wherein the encryption key is an encryption key value derived from the password, and wherein the encryption key value is derived from at least one of a sub-portion of the password, a combination of the password and the entity identifier, a portion of the combination of the password and the entity identifier, a combination of the password and a password creation time, a combination of the password and a last access time, or the password and an access statistic.

4. The method of claim 1, further comprising:
receiving a request to access the protected computing resources from a requesting computing device, wherein the request specifies the entity identifier and a supplied password;
retrieving, from the secured database, an entry corresponding to the entity identifier, wherein the entry specifies a stored hash value and a stored encrypted salt value;
generating, based on the supplied password in the received request, a decryption key value;
decrypting the encrypted salt value from the retrieved entry to generate a decrypted salt value; and
validating the supplied password based on the decrypted salt value.

5. The method of claim 4, wherein validating the supplied password based on the decrypted salt value comprises:
combining the decrypted salt value with the supplied password to generate a supplied salted password;
inputting the supplied salted password to the hash function to generate a supplied hash value; and
comparing the supplied hash value to the stored hash value in the retrieved entry to determine if the entity is an authorized entity to access the protected computing resources.

6. The method of claim 5, wherein comparing the supplied hash value to the stored hash value comprises, in response to determining that the supplied hash value matches the stored hash value, granting access to the protected computing resources and returning a notification to the requesting computing device indicating that the requesting computing device is granted access to the protected computing resources.

7. The method of claim 5, wherein comparing the supplied hash value to the stored hash value comprises, in response to determining that the supplied hash value does not match the stored hash value, denying access to the protected computing resources and returning a notification to the requesting computing device indicating that the requesting computing device cannot access the protected computing resources.

8. The method of claim 1, wherein:
the salt value is regenerated after each successful access of the protected computing resource by the entity and a new salted password is generated based on the regenerated salt value,
in response to regeneration of the salt value, the hash value is regenerated based on the hash function, the password, and the new salt value, and
the encrypting and storing operations are performed with regard to the new salt value.

9. A computer program product comprising a computer readable storage medium having a computer readable program stored therein, wherein the computer readable program, when executed on a computing device, causes the computing device to:
receive an entity identifier and password for authenticating an entity to access a protected computing resource;
generate a salt value as a random value that is combined with the password to generate a salted password;
generate a hash value based on a hash function and the salted password as an input to the hash function;
generate, based on the password, an encryption key for encrypting the salt value;
encrypt the salt value based on the encryption key and an encryption algorithm to generate an encrypted salt value; and
store the entity identifier, hash value, and encrypted salt value in a secured database for later retrieval to validate subsequent access requests specifying the entity identifier.

10. The computer program product of claim 9, wherein the encryption key is the password.

11. The computer program product of claim 9, wherein the encryption key is an encryption key value derived from the password, and wherein the encryption key value is derived from at least one of a sub-portion of the password, a combination of the password and the entity identifier, a portion of the combination of the password and the entity identifier, a combination of the password and a password creation time, a combination of the password and a last access time, or the password and an access statistic.

12. The computer program product of claim 9, wherein the computer readable program further causes the computing device to:
receive a request to access the protected computing resources from a requesting computing device, wherein the request specifies the entity identifier and a supplied password;
retrieve, from the secured database, an entry corresponding to the entity identifier, wherein the entry specifies a stored hash value and a stored encrypted salt value;
generate, based on the supplied password in the received request, a decryption key value;
decrypt the encrypted salt value from the retrieved entry to generate a decrypted salt value; and
validate the supplied password based on the decrypted salt value.

13. The computer program product of claim 12, wherein validating the supplied password based on the decrypted salt value comprises:
combining the decrypted salt value with the supplied password to generate a supplied salted password;
inputting the supplied salted password to the hash function to generate a supplied hash value; and
comparing the supplied hash value to the stored hash value in the retrieved entry to determine if the entity is an authorized entity to access the protected computing resources.

14. The computer program product of claim 13, wherein comparing the supplied hash value to the stored hash value comprises, in response to determining that the supplied hash value matches the stored hash value, granting access to the protected computing resources and returning a notification to the requesting computing device indicating that the requesting computing device is granted access to the protected computing resources.

15. The computer program product of claim 13, wherein comparing the supplied hash value to the stored hash value comprises, in response to determining that the supplied hash value does not match the stored hash value, denying access to the protected computing resources and returning a notification to the requesting computing device indicating that the requesting computing device cannot access the protected computing resources.

16. The computer program product of claim 9, wherein:
the salt value is regenerated after each successful access of the protected computing resource by the entity and a new salted password is generated based on the regenerated salt value,
in response to regeneration of the salt value, the hash value is regenerated based on the hash function, the password, and the new salt value, and
the encrypting and storing operations are performed with regard to the new salt value.

17. An apparatus comprising:
at least one processor; and
at least one memory coupled to the at least one processor, wherein the at least one memory comprises instructions which, when executed by the at least one processor, cause the at least one processor to:
receive an entity identifier and password for authenticating an entity to access a protected computing resource;
generate a salt value as a random value that is combined with the password to generate a salted password;
generate a hash value based on a hash function and the salted password as an input to the hash function;
generate, based on the password, an encryption key for encrypting the salt value;
encrypt the salt value based on the encryption key and an encryption algorithm to generate an encrypted salt value; and
store the entity identifier, hash value, and encrypted salt value in a secured database for later retrieval to validate subsequent access requests specifying the entity identifier.

18. The apparatus of claim 17, wherein the encryption key is the password or is derived from the password.

19. The apparatus of claim 17, wherein the instructions further cause the at least one processor to:
receive a request to access the protected computing resources from a requesting computing device, wherein the request specifies the entity identifier and a supplied password;
retrieve, from the secured database, an entry corresponding to the entity identifier, wherein the entry specifies a stored hash value and a stored encrypted salt value;
generate, based on the supplied password in the received request, a decryption key value;
decrypt the encrypted salt value from the retrieved entry to generate a decrypted salt value; and
validate the supplied password based on the decrypted salt value.

20. The apparatus of claim 19, wherein validating the supplied password based on the decrypted salt value comprises:
combining the decrypted salt value with the supplied password to generate a supplied salted password;
inputting the supplied salted password to the hash function to generate a supplied hash value; and
comparing the supplied hash value to the stored hash value in the retrieved entry to determine if the entity is an authorized entity to access the protected computing resources.
